(19) United States
(12) Patent Application Publication
(10) Pub. No.: US 2015/0100638 A1
(43) Pub. Date: Apr. 9, 2015

(54) ON-LINE CLOUD PLATFORM FOR LIFE LEGACY BUILDING

(71) Applicant: Melody A. Cofield, Rochester, NY (US)

(72) Inventor: Melody A. Cofield, Rochester, NY (US)

(21) Appl. No.: 14/504,655

(22) Filed: Oct. 2, 2014

Related U.S. Application Data
(60) Provisional application No. 61/886,570, filed on Oct. 3, 2013.

(51) Int. Cl. H04L 29/08; G06F 17/30

(52) U.S. Cl. CPC H04L 67/10; G06F 17/30312
USPC 709/204

(57) ABSTRACT

The present invention is a cloud-based, personal productivity and life enhancement tool comprising a central server connected to the internet for containing at least one personal productivity and life enhancement modules, wherein the central server is connected to a searchable information database store for privately keeping user information generated from the at least one personal productivity and life enhancement modules, and at least one user interface for accessing the personal productivity and life enhancement modules and searchable information database store. The preferred personal productivity and life enhancement modules comprise a daily life log module, an illumination module, a vision module, an achievement module, and a revelation module.

### CROSS REFERENCE TO RELATED APPLICATIONS

Priority is claimed to: U.S. Provisional Patent Application Ser. No. 61/886,570 by M. Cofield, entitled “ON-LINE CLOUD PLATFORM FOR LIFE LEGACY BUILDING”, filed on Oct. 3, 2013, the disclosure of which is incorporated herein by reference.

### FIELD OF THE INVENTION

The present invention relates to an online cloud platform containing integrated and free-flow modules with unique features and tools to help individuals think strategically and creatively, establish a pathway for living their dreams, stay focused, and remain organized in their pursuits. Essentially, DIVAR is a personalized platform that puts the individual in the driver seat of their life—anywhere, anytime.

### BACKGROUND OF THE INVENTION

DIVAR was developed after more than twenty-years of producing personal development, entrepreneurship, and leadership programs for organizations, individuals, and emerging leaders. During this time, it was noticed that women engage in certain behaviors and are victims of environmental circumstance that have a negative effect on their potential to succeed, more so than men. Among the top five of these behaviors showed that women:

Are likely to have their voices unheard, contributions unrecognized, and stories untold;

Experience personal set-backs sacrificing and caring for others;

Often lose track of their own goals in favor of supporting the goals of others;

Are overwhelmed by constant change and the unexpected; and

Often lose confidence in their talents and abilities.

These characteristics were found to be common across 5-generations of women. While not all women share all five of the behaviors, many of them identified with at least one.

It was further noticed that women operated more at their potential when they have access to support systems, learning methods, and tools unique to their learning styles and personal orientations. Recognizing the impact, writing techniques known to have a long-standing history of working on the unconscious and evoking creative abilities were explored. More writing techniques were incorporated into the design of the programs and the positive effect they had on women in both professional and entrepreneurial environments was observed. These special tools included personal reflection, journal feedback techniques, storytelling, and progress tracking, to name a few.

Encouraged by the results, the inventor realized that limiting programs to just local workshops affected the ability to reach greater numbers of women. Turning to the latest advances in online and social technology, these tools were integrated with technology as a scalable way to globally market and reach more women directly. DIVAR is the result of this collaboration.

### PROBLEM TO BE SOLVED

Systems and methodologies for effecting positive changes in human behavior to develop individuals, particularly for children, adolescents and young adults, are numerous. However, solutions to effect changes in certain behaviors, educate and inform, and promote personal development are varied, fragmented and typically only target one or a few behaviors. For example, various and disjointed solutions are available in behavior rewards, scheduling, task and project management, goal-setting, social skills, values development, and weight management. Such solutions tend to be so numerous, disjointed, and varied that their use becomes overwhelming and unwieldy for helping behavior development across a numerous areas of human behavior, thus failing to provide integrated, comprehensive and/or holistic solutions. For example, known applications such as iChores, iHomework, iStudiez Pro, Kids Paid, and myHomework offer only limited and targeted functionality, and have no interface or shared overarching functionality. There are few if any systems to aid adults in planning, balancing and directing their own lives.

### SUMMARY OF THE INVENTION

The present invention is a cloud-based, personal productivity and life enhancement tool comprising a central server connected to the internet for containing at least one personal productivity and life enhancement modules, wherein the central server is connected to a searchable information database store for privately keeping user information generated from the at least one personal productivity and life enhancement modules, and at least one user interface for accessing the personal productivity and life enhancement modules and searchable information database store. The preferred personal productivity and life enhancement modules comprise a daily life log module, an illumination module, a vision module, an achievement module; and a revelation module.

### ADVANTAGEOUS EFFECT OF THE INVENTION

The present invention includes several advantages, not all of which are incorporated in a single embodiment. The present invention can provide apps to instantly capture precious moments forever, serve as a place to store and preserve memoires, can be accessible wherever, and whenever, is a private way to safeguard stories and records, allows social media links to share with facebook (FB), Twitter, LinkedIn, and Pinterest, and can serve as storage space for documents and photos. The system can also be used by women, men, children or other groups. On a more advanced level, the invention is designed to incorporate special journaling techniques that truly empower individuals to take the action necessary to change the course of their lives and unlock their creative potential, deepen self-knowledge and reduce procrastination. The basic and advance level features make the invention a central place for individuals to find both the tools and guidance they need to balance their lives, navigate transitions, eliminate distractions, and make better choices.

### BRIEF DESCRIPTION OF THE DRAWINGS

FIG. 1 illustrates an embodiment of the cloud-based, personal productivity and life enhancement and planning tool comprising a central server connected to a searchable information database store and at least one user interface.

FIG. 2 illustrates user interface tools, including a mobile app.

FIG. 3 illustrates a preferred embodiment of the home page portal to access the modules of the invention.

FIG. 4 illustrates one embodiment of the daily log module.

FIG. 5 illustrates an embodiment of the coaching feature of the daily log module.

FIG. 6 illustrates an embodiment of the mood inventory feature of the daily log module.

FIG. 7 illustrates an embodiment of the to-do list feature of the daily log module.

FIG. 8 illustrates a preferred embodiment of the time capsule feature.

FIG. 9 illustrates an embodiment of the revision feature of the daily log module.

FIG. 10 illustrates an embodiment of the topic du jour feature of the daily log module.

FIG. 11 illustrates an embodiment of a page from the vision module which also appears as a board in the daily log module.

FIG. 12 illustrates an embodiment of a page from the achievement module which also appears as a board in the daily log module.

FIGS. 13 A and B illustrate embodiments of social media links which can be included in the modules of the present invention, typically, in the daily log.

FIG. 14 illustrates an embodiment of the illumination module.

FIG. 15 illustrates an embodiment of the twilight log feature of the illumination module.

FIG. 16 illustrates an embodiment of a time capsule feature of the illumination module.

FIG. 17 illustrates one embodiment of a template which may be contained in the illumination module to assist in development of vision and goals.

FIG. 18 illustrates a scored report from the achievement module based on the input from the template of FIG. 17.

FIG. 19 a and b illustrate exemplary life journey timelines generated by the achievement module.

FIG. 20 illustrates a mood/well-being chart generated by the achievement module, as well as one possible embodiment of the data calculated by the achievement module.

FIG. 21 illustrates an embodiment of the data calculated by the achievement module.

FIG. 22 illustrates a one possible embodiment of the data calculated by the achievement module.

FIG. 23 illustrates an embodiment of the revelation module.

FIG. 24 illustrates another embodiment of the revelation module.

### DETAILED DESCRIPTION OF THE INVENTION

At the basic level, the invention is an online cloud platform designed to help individuals, for example, men, women or children, capture, write, and preserve their life stories. On a more advanced level, the invention is designed to incorporate special journaling techniques that truly empower individuals to take the action necessary to change the course of their lives and unlock their creative potential. The basic and advance level features make the invention a central place for individuals, for example, women, to find both the tools and guidance they need to balance their lives, develop productive practices, methods and techniques, navigate transitions, eliminate distractions, and make better choices. The invention provides an effective online tool designed to centralize everything an individual needs to help them balance their lives, navigate transitions, make better choices, and eliminate distractions. This online platform puts an individual in the driver seat where they can get clear and focused about prioritizing the pathway to the future.

The inventive tool is referred to herein as DIVAR, which is an acronym for five integrated product modules:

1. Daily—A capture tool for recording life as it happens now

2. Illumination—To capture the past and uncover the life-defining patterns

3. Vision—To establish a vision and set goal

4. Achievement—For tracking and monitoring

5. Revelation—To reveal a life story

Each module has unique features and tools to help individuals think strategically and creatively, establish a pathway for living their dreams, stay focused, and remain organized in their pursuits. Essentially, DIVAR is a personalized platform that puts the individual in the driver seat of their life—anywhere, anytime.

DIVAR offers solutions that address the top 5 characteristics that thwart an individual's potential:
1. Since one is likely to have their voice unheard, their contributions unrecognized, and their stories untold, DIVAR provides a way for the individual to take a more active role in writing, recording, and telling their own story. DIVAR modules offer the individual an easy way to capture their past, present, and future. With flexible storage capacity, it allows one to preserve one's story, save documents and pictures, and print and publish their work any time.
2. No doubt, an individual will sacrifice and experience personal setbacks if they are the person who directly provides care for her children, spouse, parents, in-laws, friends, and neighbors. In doing so, the individual will play many roles as care giver-nurturer, hands-on health provider, care manager, friend, companion, surrogate decision-maker, and advocate. These competing priorities make it difficult for an individual to stay focused and keep track of their own goals and aspirations. To help them stay focused on their personal goals while serving the needs of others, DIVAR provides tools and processes to help achieve role and life balance and even track personal progress.
3. Despite life's complexities, an individual must take care of their needs and the needs of others in the midst of continuous change and the unexpected. Major event such as getting married, having children, going through a divorce, or a death all involve dealing with the unknown territory and self-discovery. These unplanned events bear huge burdens for the individual because they pull time and resources away from taking care of one's personal needs. DIVAR helps an individual navigate the beginning, middle, and end stages of any change and be able to complete multiple transitions with minimal disruption to their personal goals.
4. As a multitasker, one often loses track of one's own goals. Being able to spend quality time reflecting is an important process of the day. DIVAR offers a unique way to spend quality-guided time reflecting on both internal and external processes. This will help an individual stay focused and make better decision about their time and resources.
5. Making dreams a priority and knowing just how to manifest them into reality are the reasons an individual often loses confidence in their abilities. Anticipating everything one needs to make one's dream come true can seem daunting, if not impossible at times. Using Diver's tools, one will have a place to sort through all the pieces of the puzzle and rebuild their confidence.

DIVAR's integrated modules offer people a distinct set of value propositions.

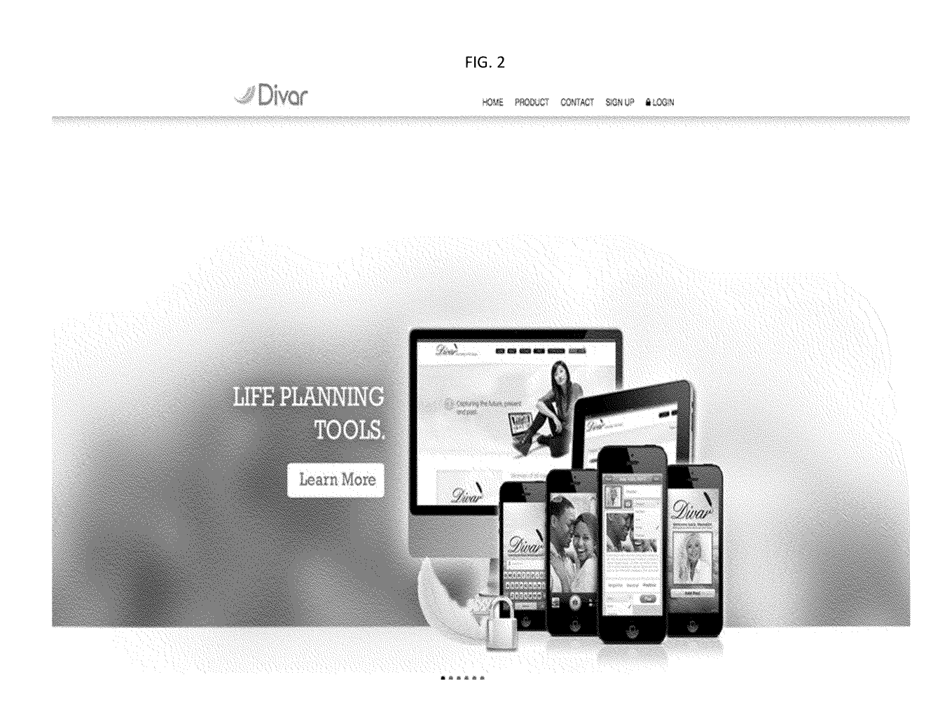

They help:
Unlock the book within. DIVAR's guided tools help to reveal an individual's unique story or any story with professional looking documents, which can be printed or shared publically.
Capture, write, preserve, and tell life stories. DIVAR provides a safe place to write, edit, and publish stories—past, present, and future. DIVAR's family pack enables one to also unpack the stories of children, parents, friends, and loved ones, when and if chosen.
Instantly capture the most precious moments. Such moments can be captured in words, pictures, audio, and video using the cloud platform—anytime, anyplace. Even the DIVAR mobile app allows precious moments to be instantly captured and sent to DIVAR. See FIG. 2.
Illuminate life-defining patterns. Understanding life-defining moments, turning points, and stepping-stones can illuminate old patterns, feelings, and themes one has acquired that frame how one defines themselves. These patterns frame behaviors that influence how a person acts, thinks, and feels; consequently, they influence the results one gets in life. DIVAR will help a person reinvent themselves by discovering and redefining their most influential patterns.
Design focus and clarity in all areas of life. With DIVAR, a person will be guided to align life purpose and values into all areas of life.
Visualize the future, identify goals, and monitor progress. One can turn any dream into reality using DIVAR to visualize the future, establish goals, and track progress.

Each module has unique features and tools to help individuals think strategically and creatively, establish a pathway for living their dreams, stay focused, and remain organized in their pursuits. Essentially, DIVAR is a personalized platform that puts the individual in the driver seat of their life—anywhere, anytime.

With DIVAR, a person can capture and organize thoughts, be reminded to capture precious moments, explore passion and purpose, record personal trials and tribulations, discover obstacles, overcome adversity, capture words of wisdom for future generations, spend time to be reflective and introspective, make decisions, take action, take action on reflective discovery, reveal and expose personal themes, write letters and store them safely, compose their own amazing stories, capture fond memories for keepsake, capture family history, store family documents, letters, commendations, and pictures, compose great quotes, start recording one's children's legacy, capture the legacy of family and friends, keep family recipes, keep prayers and favorite verses, spend time nurturing the woman/man within, capture the legacy of parents, and write one's legacy story. The intent is that the tool be a private repository, but the user can give limited access to designated parties through an access code system, if desired.

Additional features from the internet or individual experts or expert source may be accessible through the tool. Features to purchase products can also be included, as well as links to other features of interest. A features may include building content for sharing via social media, uploading website pages, as well as downloading selected photos, documents, etc., composing a legacy bio, building content for blogs and social media, access guided coaching, administer and integrate a personality assessment profile, and media for improving wellbeing, health, spirituality, fitness, beauty, entrepreneurship, finances, transitions, branding, careers, circle of influence, and relationships.

Although aimed primarily at individual consumers, DIVAR can be used by other groups, such as printers/publishers, professional coaching services, and self-help media producers. DIVAR's core platform offers both basic and advance level modules and features to direct users.

The most logical of these matchings are printing service providers and professional coaches. When users finish writing their documents through the revelation module, they may want to and be able to share all or a portion of it with family and friends, or even business clients. Conveniently matching a print-service to these primary users with just a click provides added value and convenience. Developing the product platform to handle these transactions allows us to be used as a distribution channel for printers connecting them to print customers from the user base.

The same is true for coaching. While working through the illumination, vision, and achievement modules, users may decide they need further help in specific areas, including: entrepreneurship consulting, life-balance or well being coaching, and/or authorship consulting. When this happens, matching coaches quickly and easily through the DIVAR platform provides a higher level of service to users and allows us to serve as a distribution channel for coaches connecting them directly to customers with coaching needs.

DIVAR has designed a clickable expert feature that opens up to vidios and audio streams to offer the ability for user receive instant online advise. Operating the platform as a distribution channel for self-help product/service providers provide a host of matched services that meet the needs of the users. Examples include meditation and music audios, workout/yoga exercise video streams or how-to video and audio instructions.

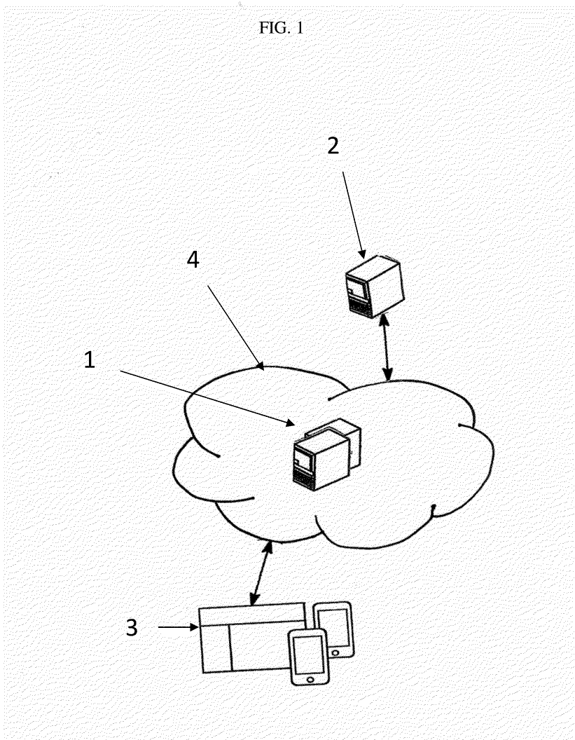

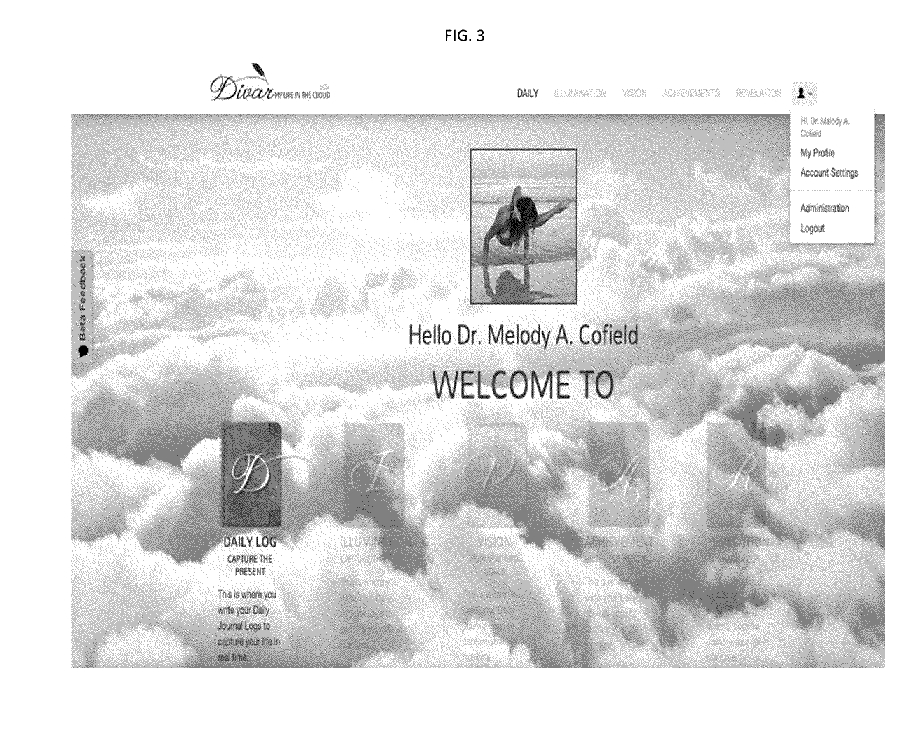

Specifically, the present invention relates to a cloud-based, personal productivity and life enhancement and planning tool comprising a central server 1 connected to the internet 4 for containing personal productivity and life enhancement modules, wherein said modules comprise a daily life log, an illumination module, a vision module, an achievement module; and a revelation module, illustrated in FIG. 3, wherein the central server is connected to a searchable information database store, also referred to as a personal, searchable repository, 2 for privately keeping user information generated from the modules, and at least one user interface 3 for accessing the modules and database store, as illustrated in FIG. 1. The modules are searchable by the user, using key words, such as date, title, mood, etc. Features, for example a photos or log entries, are drag-able to other modules of the invention. Log filters may include new entry date, update date, period (begin-end, begin-present), period name, period category tag, dimension, log title, other tags, personal history log, dream log, dialogue logs, meaning logs and twilight log.

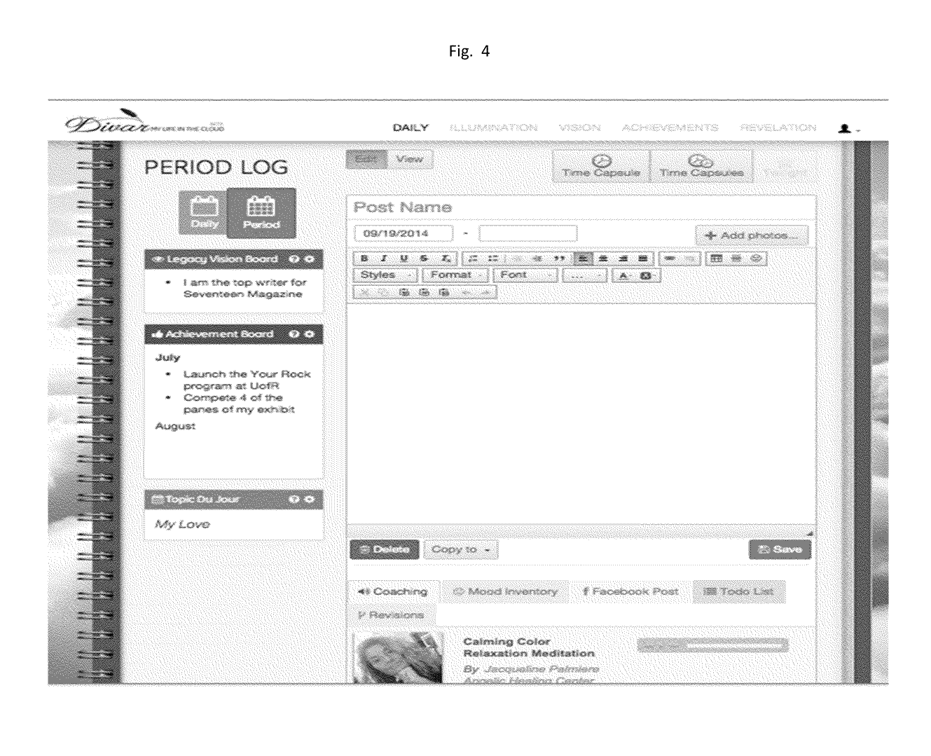

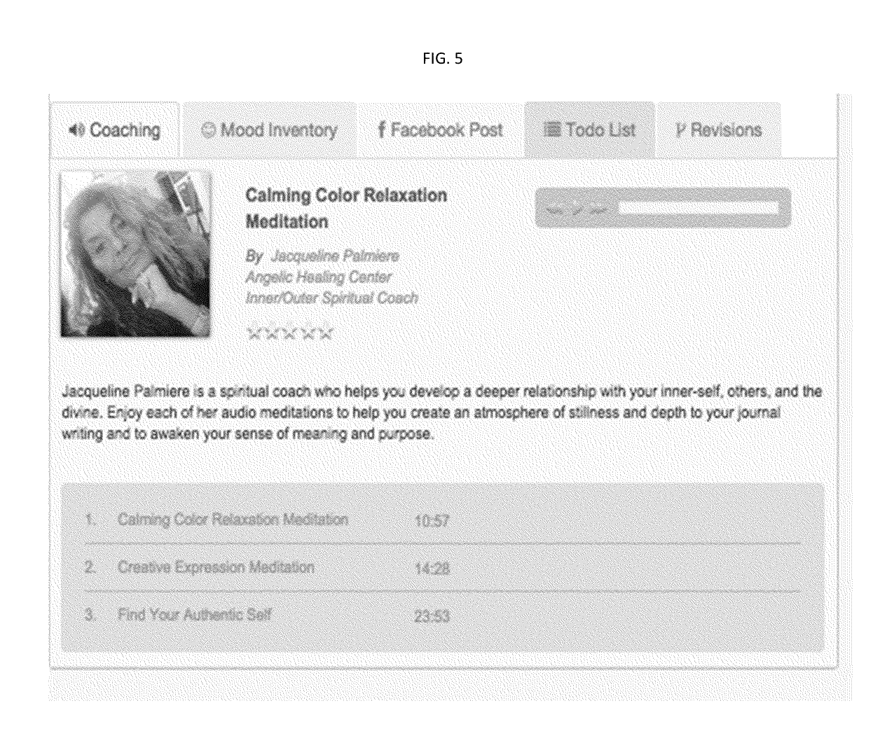

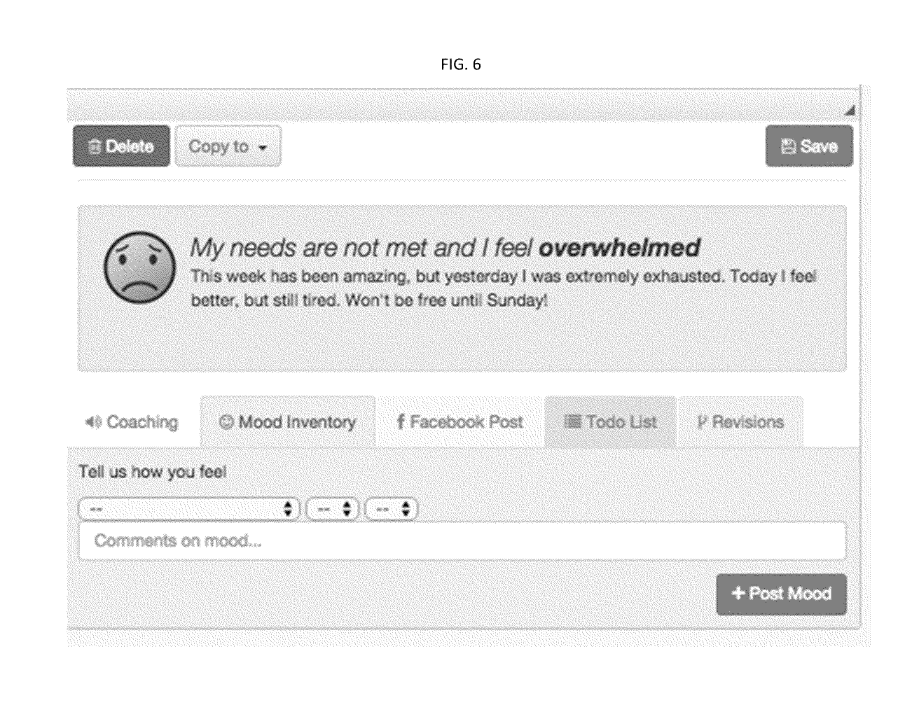

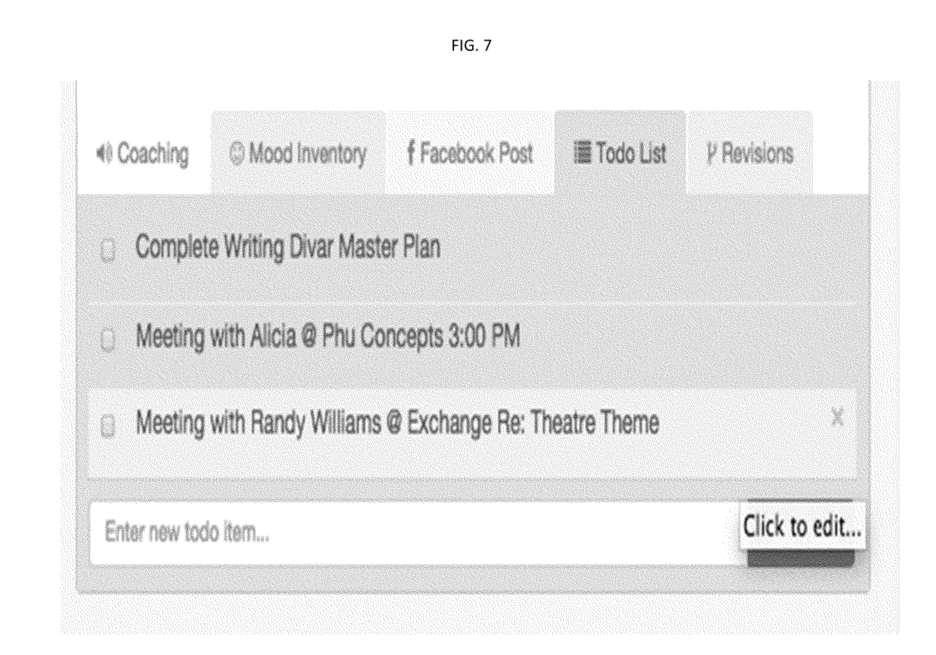

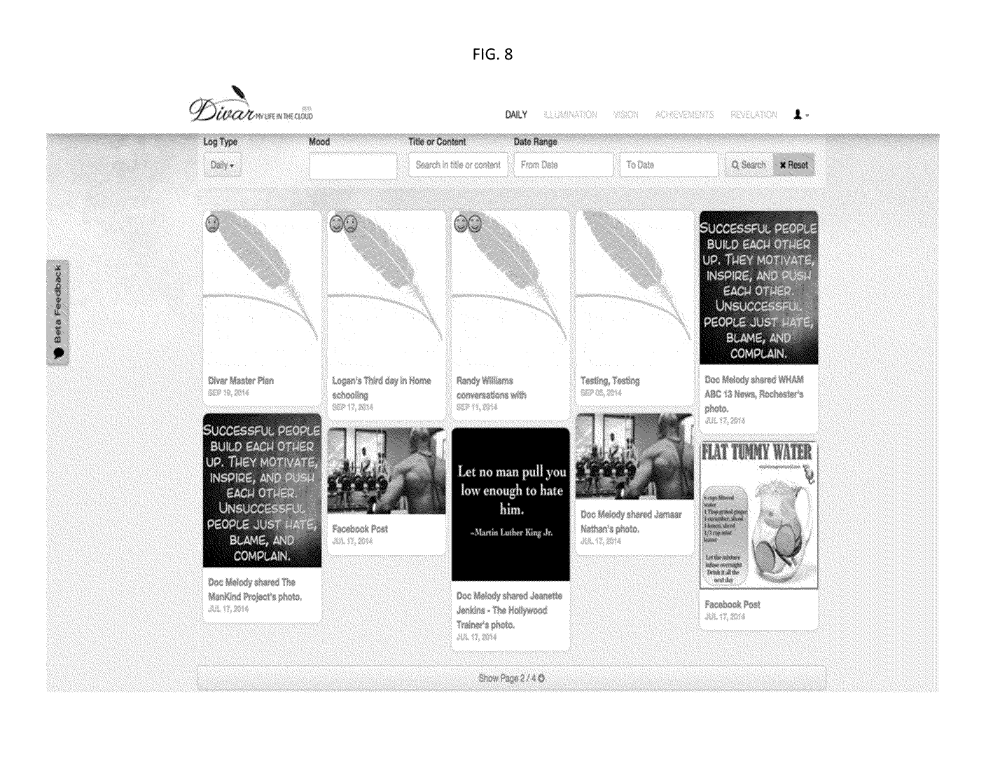

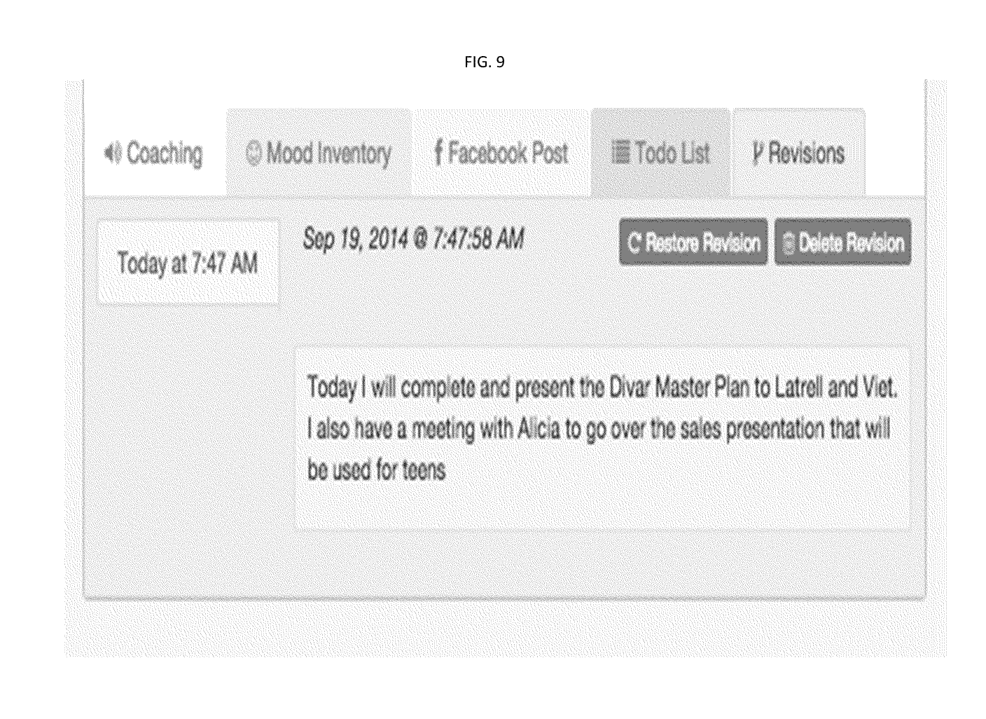

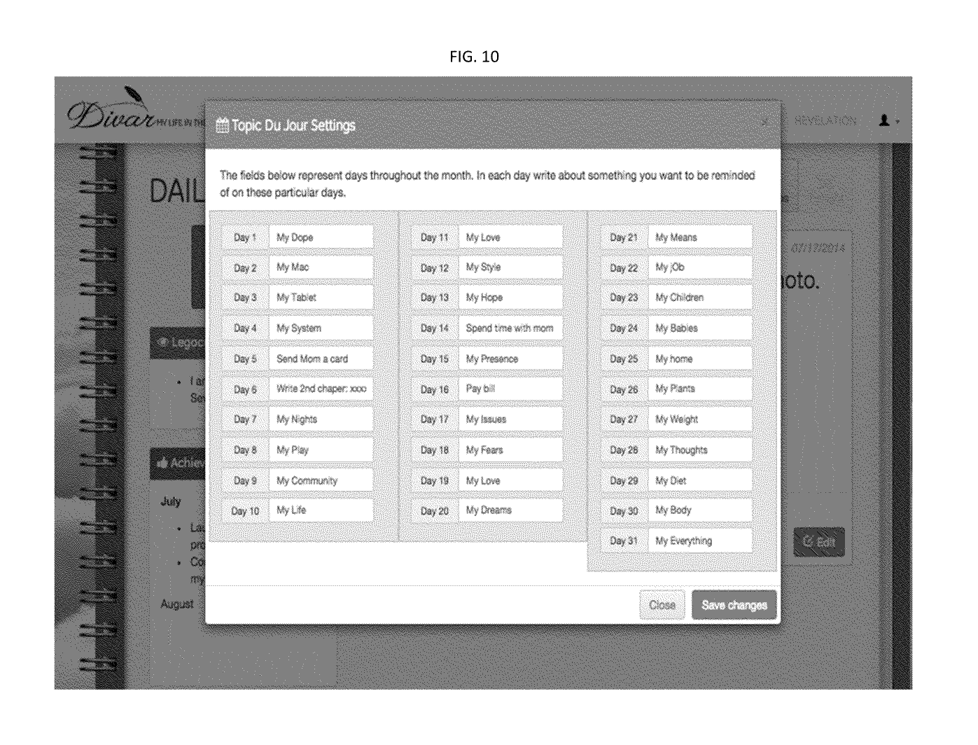

The daily life module has several parts, referred to herein as features. The most important feature is the word processing feature, referred to as the daily log designed to contain a title for each log and accompanying text or photographic section in which the user enters events of the day. An additional feature is a period log, illustrated in FIG. 4, similar to the daily log, as it has a title and a text section but has user-designated time periods other than 1 day. One feature is a coaching feature, illustrated in FIG. 5. The coaching features is designed to connect the user to various information and sources that may provide assistance in improvement in one of the themes that may arise out of the daily logs as well as learnings in other modules. This section can include links to experts for communication via written, audio or visual communication, for instance, through Skype, as well as businesses that may be selling pertinent products for life planning. Another feature is a mood inventory in which the user can access a list of moods and assign them to a day or event in the day. See FIG. 6. An emoticon may be used. The daily life module also includes a section for creating a to-do list, illustrated in FIG. 7. Another feature in the daily life module is called a time capsule, illustrated in FIG. 8, which visually summarizes the titles of the daily log, moods, photographs and announcements, to name a few, to produce a summary page illustrating daily summaries, providing an overview of activities over time. Additional add-ons may be included, such as a topic du jour feature, illustrated in FIG. 10, chosen from a predetermined list of 30 topics or automatic reminders based on the to-do list. There is also an option to revise entries in the daily life module. See FIG. 9.

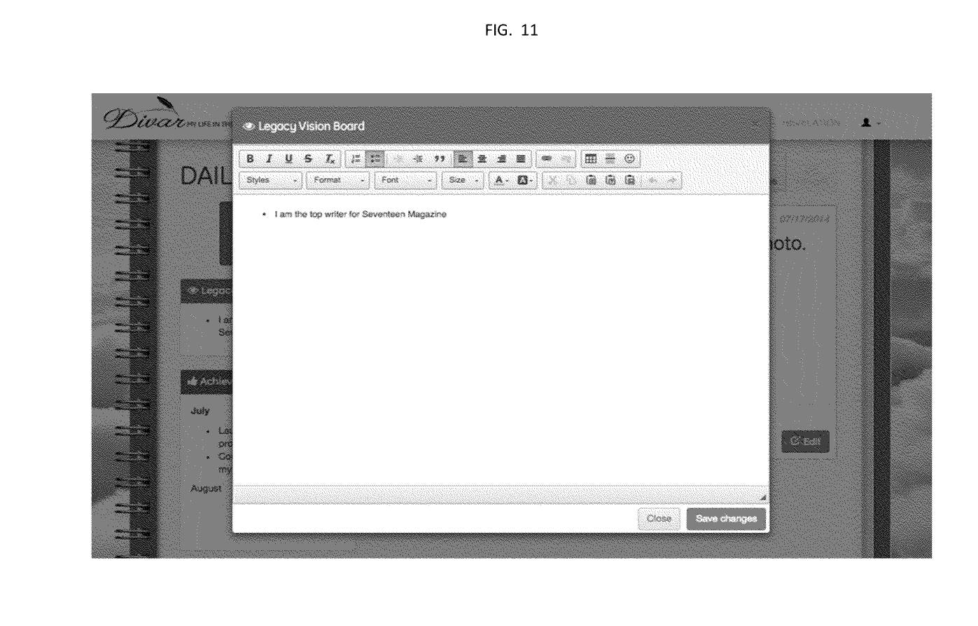

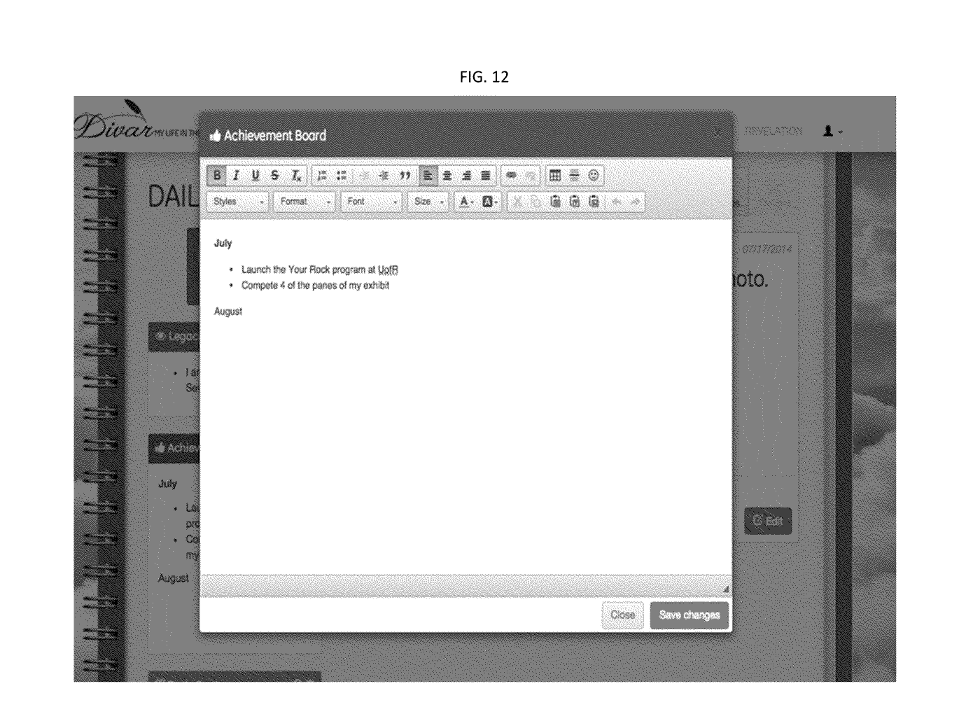

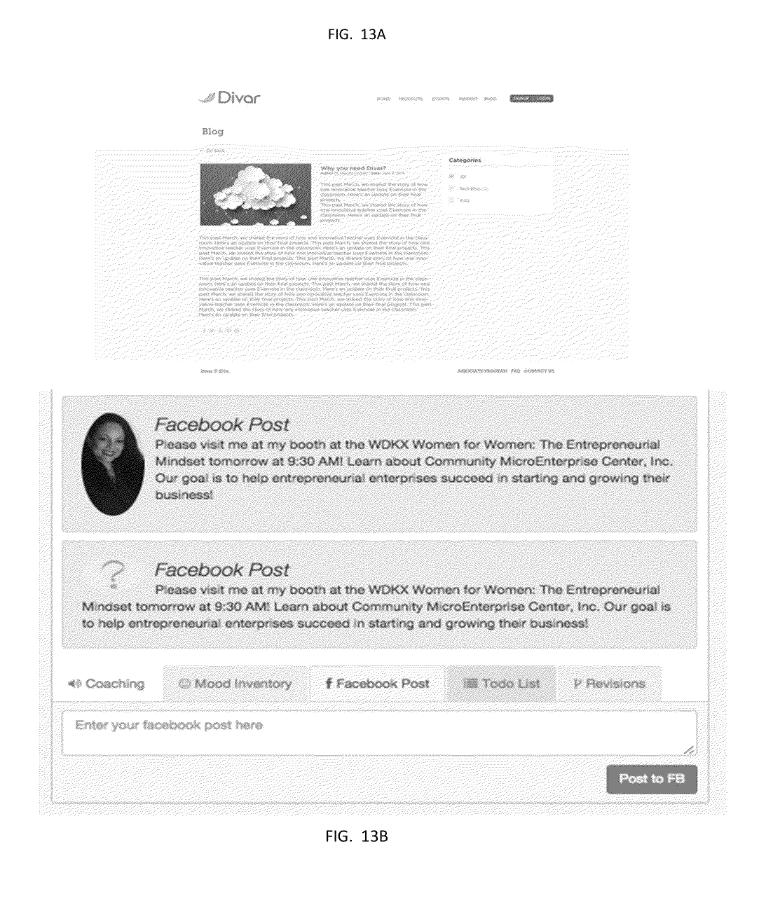

The daily log module may contain information from other modules on the visible page. For example, a vision board, illustrated in FIG. 11, may contain goals or pictures imported from the vision module or an achievement board may appear, illustrated in FIG. 12, based on data calculated from the vision module by the achievement module. There may also be a link to social media to allow easy upload of parts of the daily log to the users' social media accounts. See FIGS. 13 a and b. Another feature called the journey catcher can automatically download content from face book to generate your daily logs or other designated modules.

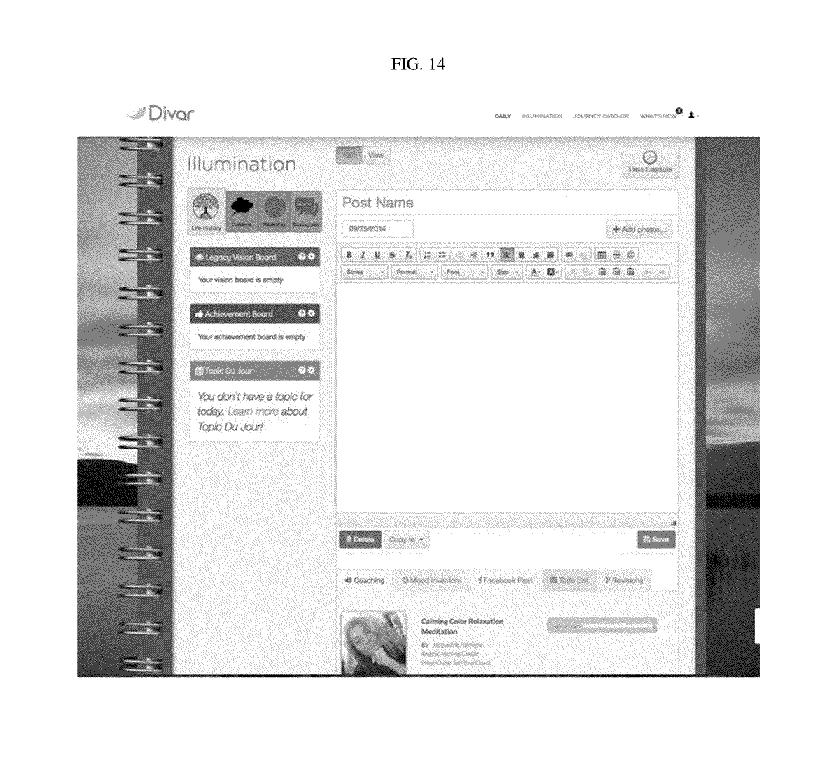

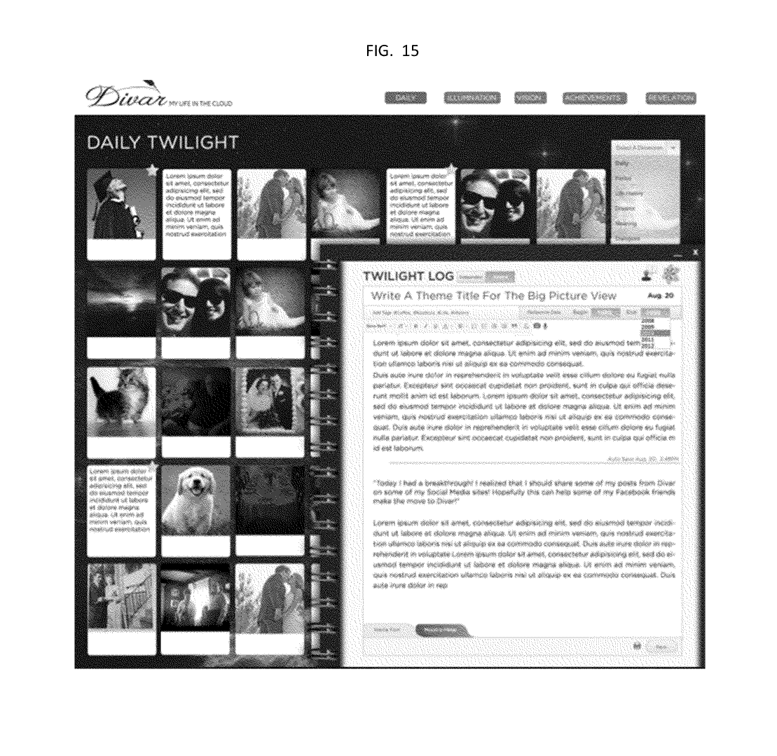

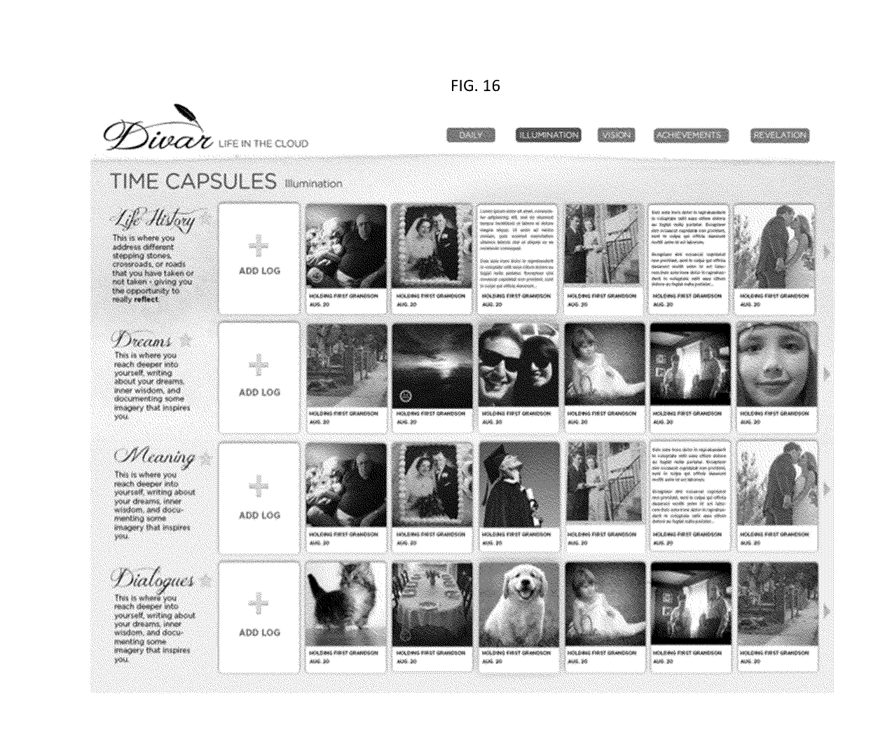

The illumination module, a life integration tool that provides a way to understand the effects of life defining moments, turning points, and stepping stones that influence actions and performance, illustrated by FIG. 14, contains word processing features, having a title and a text or picture section, in different sections for dreams, conversations (with self or others), meaning, and history. For example, a user records a dream they had and assigns a title. A twilight log, designed as a pop-up, is available which shows a visual summary of the titles, allowing an individual to look for recurring patterns over time, which may lead to understanding recurring themes in the individual's life. See FIG. 15. This module may also contain a time capsule feature, illustrated in FIG. 16, similar to the feature contained in the daily life module described above. The features, for example, the twilight log and time capsule, look to the daily information and summarize key filters to show an overview that can help the user see patterns of behavior, etc. These features can be used multiple times, e.g., to summarize the tags associated with each summary, to continuously higher levels. Think of a hierarchy pyramid. This module may contain links to services to help change, improve or reinforce the themes. Such links may include music, meditation, professional counselors, etc. Features of this module can include the display of thumbnails across various filters, selection of time spacing mode, and display of thumbnails with a pop-up twilight log.

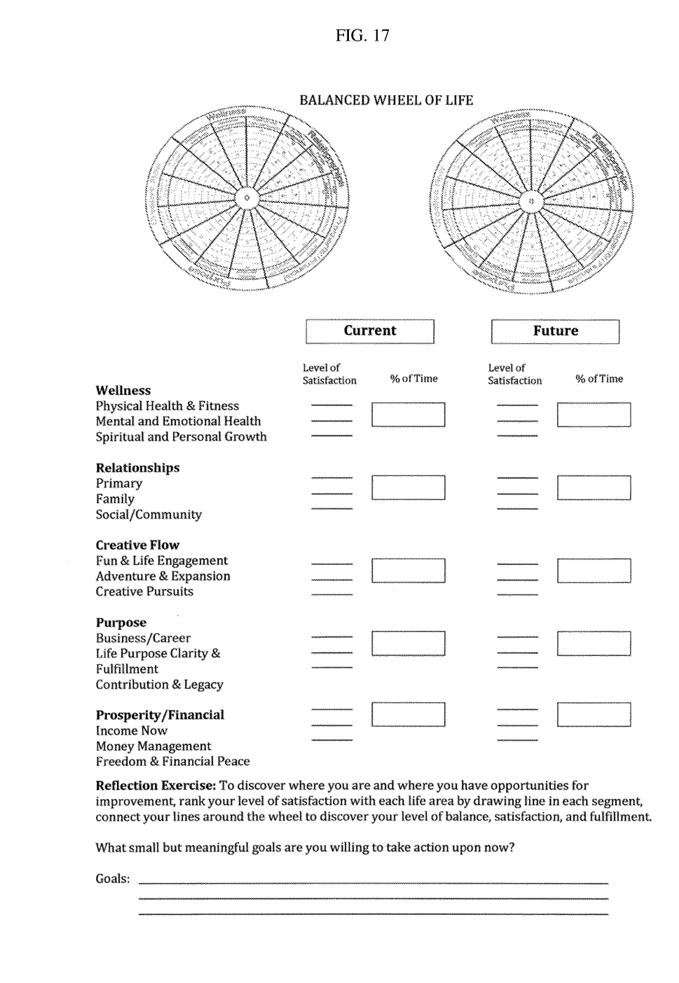

The vision module, a life-plan creator, balancer and prioritizer for personal, business and family plans, contains a section for developing and maintaining an individual's vision statement and a section for goals. The vision module assists the user with life alignment, to manage goals, work-life balance, and navigate transitions. The goal section is divided into 8 categories to create a specific vision with goals, objectives, and achievements identified. The vision module assists the user in developing, retaining, storing and maintaining annual milestones, such as annual goals, or milestones for any other desired length of time. A vision board, illustrated in FIG. 17, which may include pictures, is tied to each of the following eight areas:

Personal Vision: Who are you? What is your identity? What is your legacy? What will you leave behind?
Personal Care: What do you do with your energy and your body? How do you care for yourself? Specific areas can include physical health & fitness, rejuvenation, restoration, medical issues, wellbeing and beauty, for example.
Relationships—How do you interact? Who helps you? Who do you help? Who do you influence? Who influences you? Specific areas can include community, friends, associates, colleagues, mentors, advisors, partner, circles of influence, social media, for example.
Family: Who will you reproduce? Who are you committed to? Who will you care for? Who will care for you? Specific areas can include children, marriage-spouse, grandchildren, parents, and relatives, for example.
Contribution: How will you give? Specific areas can include social service and giving, for example.
Personal and Spiritual Growth: How do you feel? What will you do? What do you believe? Specific areas can include passion & purpose, and creative flow, training, and education, for example.
Industry: How will you help? Who will you help? What will you give? Specific areas can include career, work, livelihood, skills and knowledge requirements, for example.
Prosperity: What do you get? What do you need? What quality of life do you want/need?
Specific areas can include sustainability, financial wealth, assets, revenue, expenses, and profitability, for example.

Templates can be added to the illumination module to assist in the development of a vision and goals. See, for examples, FIG. 17.

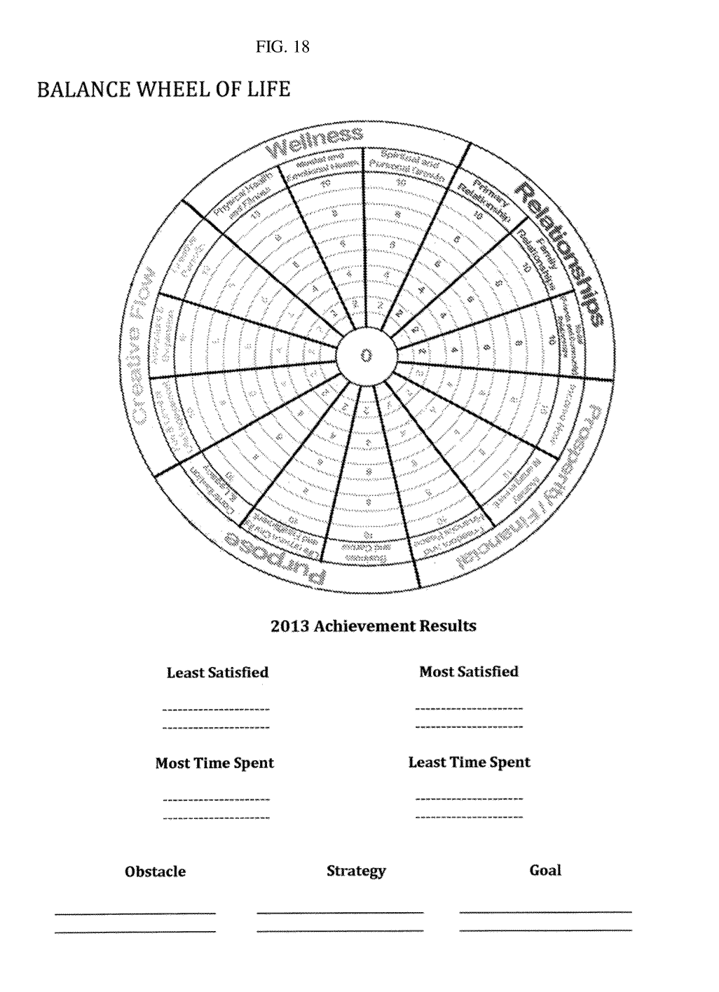

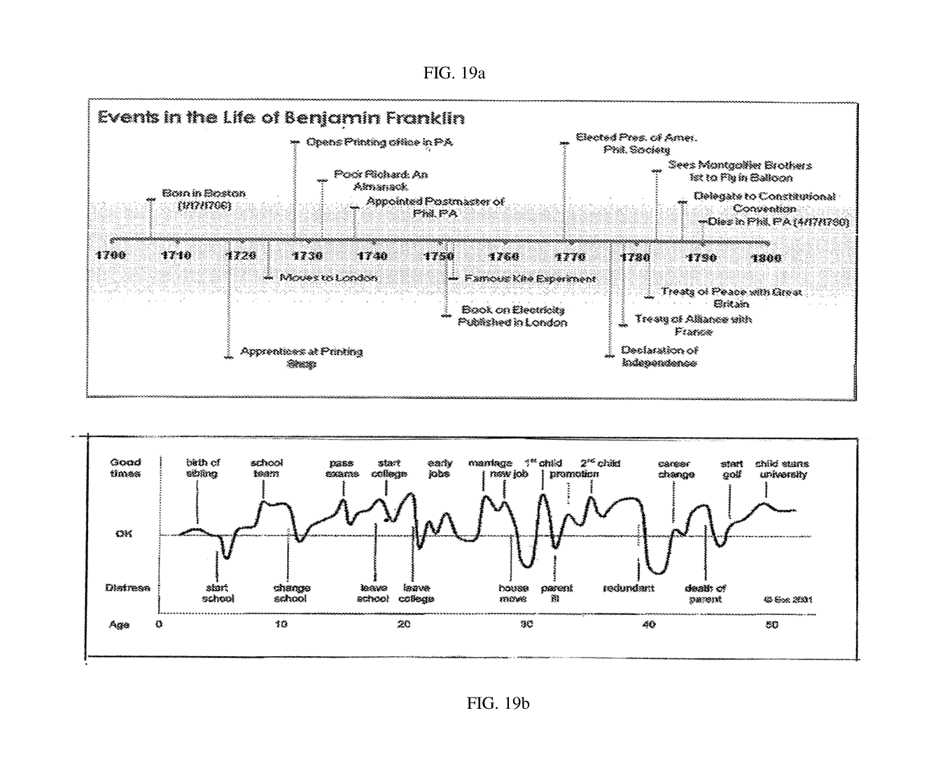

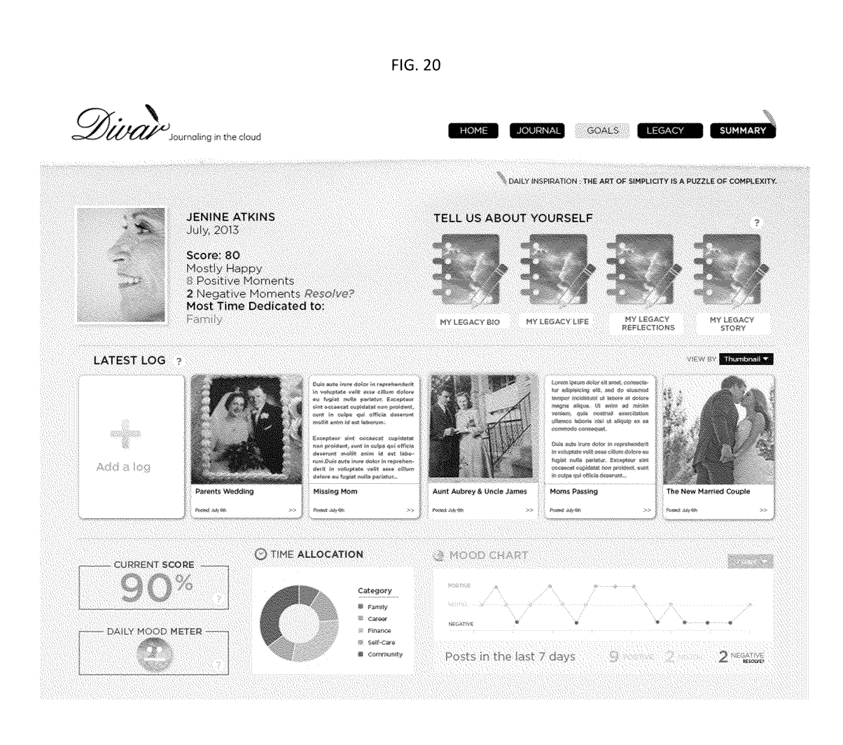

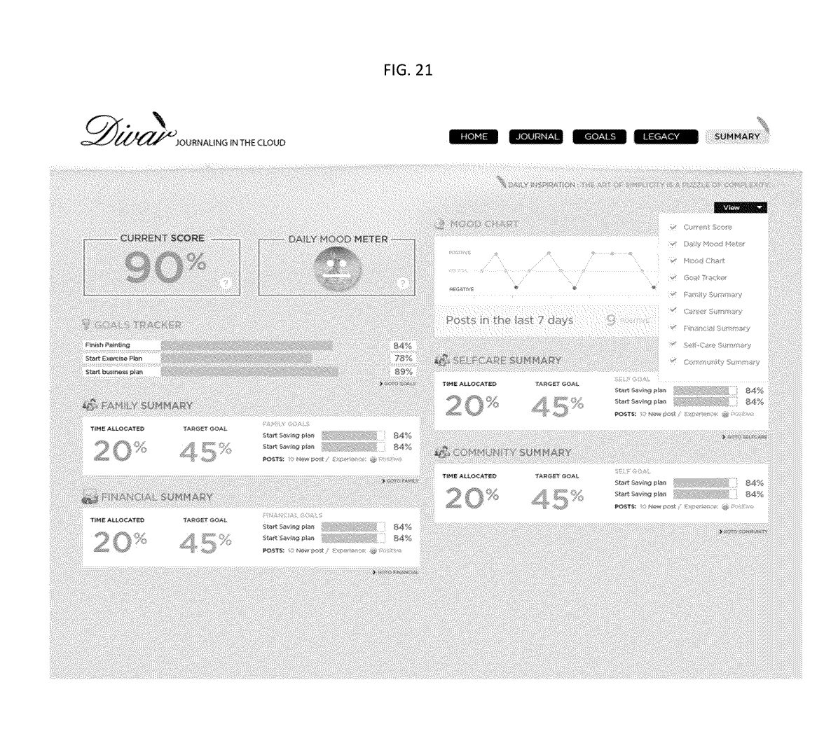

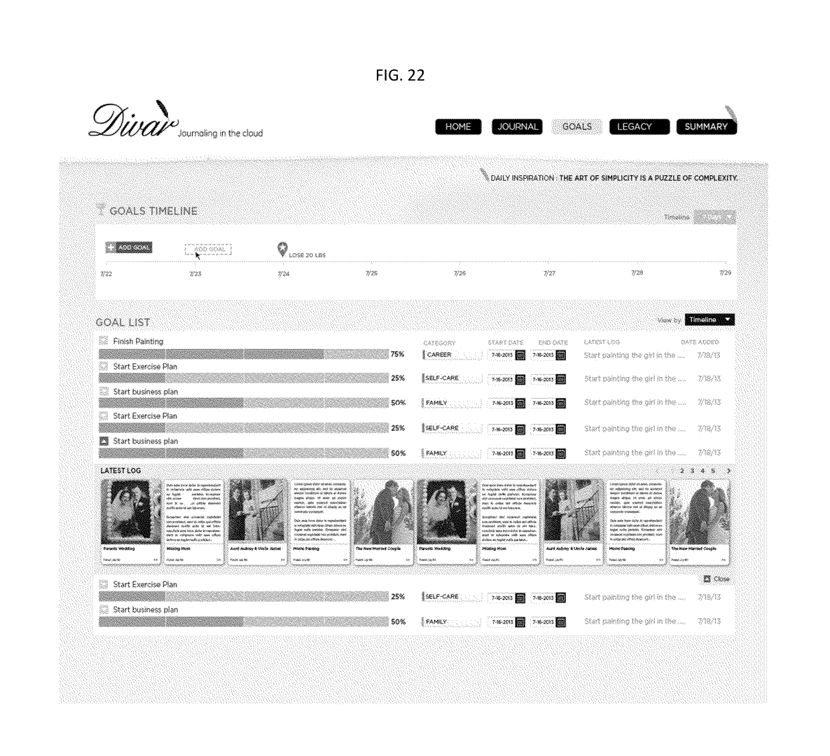

The achievement module, a life-plan tracker, calculates. This module takes data from the vision module and develops reports, charts, scorecards, etc. These data may be imported and displayed in other modules to help with the user's analysis and assessment. FIG. 18 illustrates an achievement report, based on a template from the illumination module, shown in FIG. 17. Another feature of this module is the development of a life journey timeline, illustrated in FIGS. 19 a and b, or a mood/well-being chart, illustrated in FIGS. 20 and 21. This module can also be used to measure the results of goals is the 8 vision categories and identify how much time has been spent on each category and toward achieving each goal. See FIGS. 20, 21, and 22.

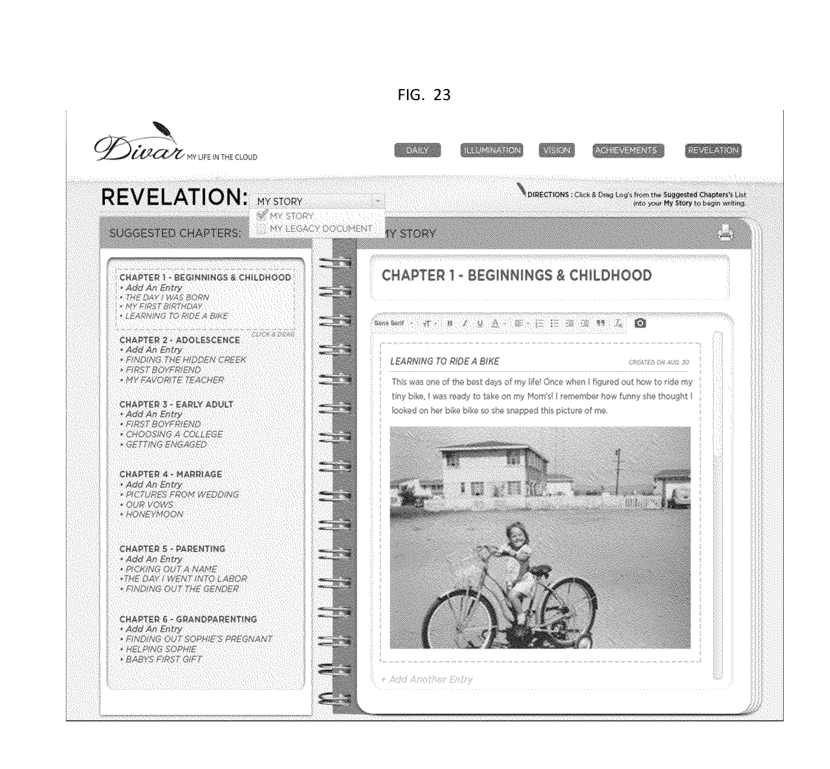

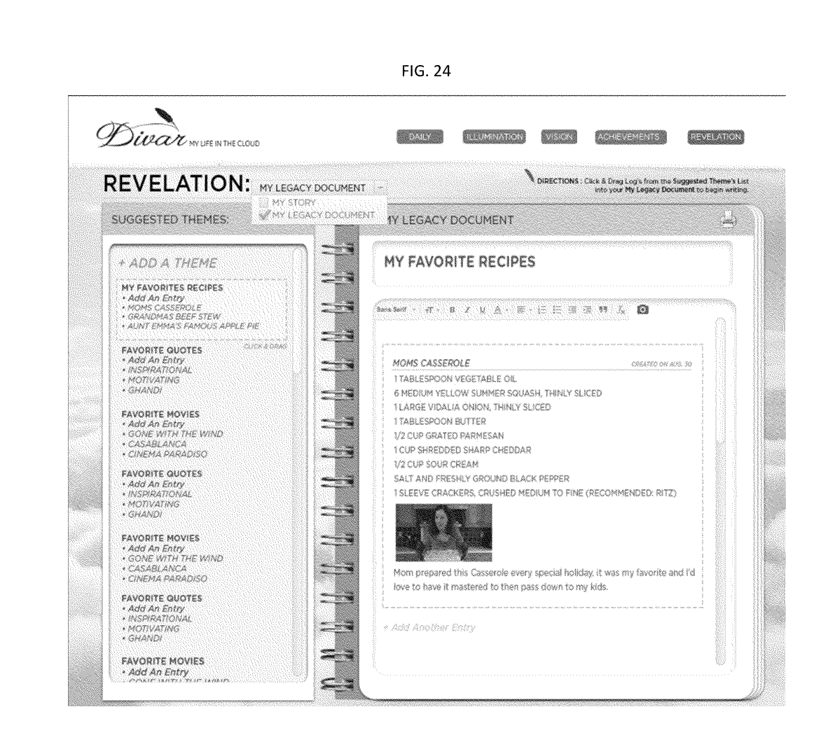

The revelation module, a life story writer, organizes and chronicles to reveal the user's life through writing. See FIG. 23. The module can be utilized in either a guided or unguided version. In the guided version, questions are presented and a story is generated based on the input. In the unguided section, the user writes their own stories, summaries, histories. The revelation module can capture special events milestones, defining moments and turning points. This module may contain links to publishing services, formats, etc. This module may also contain writing-related templates or tools, such as a cover page, short memoir, reflections, vignettes, narratives, scrapbooking tools, portfolio templates, for example, family, school, faith-based, community/social/civic, career, global/cultural and self-leadership, character building, interviews, personal essays, songs, sayings, quotations, recipes, poems, prayers, testimonies, family acknowledgements, and even a blank page. This module may contain features to assist in writing the individual's autobiographies and biographies via drag-and-drop systems including, for example, my beginnings & childhood, adolescence, early adult years, relationships, marriage, parenting, middle adult years, grand parenting, and the golden years. See FIG. 23. This module can also be used to collect and organize other written works, which the individual may later wish to be published, as illustrated in FIG. 24. Other included features can allow the individual to use predesigned pages, upload pictures, insert pictures, spell check, and auto save.

The tool can include software for displaying and providing access to independent learning activities via a mobile application, a web browser plug-in, add-in, add-on, toolbar, or extension.

The present invention includes at least one user device or interface to communicate with a network which provides functionalities to the one or more user devices.

The user interface or device is a capture tool for DIVAR and can be a non-portable device, such as a server or a desktop computer, a portable device, such as a laptop or tablet computer, a mobile device, such as a smartphone or digital music player. Typical components of a user device can include an operating system configured to perform executable instructions, a memory device, a visual display, such as a cathode ray tube (CRT), plasma display, video projector or a liquid crystal display (LCD), an input device, such as a keyboard or keypad, mouse, trackball, track pad, joystick, game controller, or stylus, touch screen, microphone, video camera, and, optionally, a sound output device. Examples of suitable user devices can include server computers, desktop computers, laptop computers, notebook computers, tablet computers, netbook computers, smart book computers, subnotebook computers, ultra-mobile PCs, handheld computers, personal digital assistants, internet appliances, land lines, voice record translate devices, smartphones, music players, and portable video game systems.

The present invention includes at least one server containing the operating system and other functionalities needed to run the modules of the personal productivity and life enhancement tool. The servers can be stand-alone or intranet-based, but are preferably internet-based. The servers can be world wide web-based and/or cloud computing-based. The servers can include one or more hardware central processing units (CPU) that carry out the device's functions. The servers can include data storage devices including, by way of non-limiting examples, CD-ROMs, DVDs, flash memory devices, magnetic disk drives, and optical disk drives. Typically, the server includes a processor and the interactive DIVAR modules and is connected to a storage device. Although only a single processor and a single storage device are illustrated in FIG. 1, the server may include multiple processors and/or multiple storage devices, which may be distributed in a network of servers.

The server includes at least one computer program. The computer program includes a sequence of instructions, executable in the digital processing device's CPU, written to perform a specified task according to the modules of the present invention. The computer program may be written in various languages. The computer program comprises at least one sequence of instructions. The computer program can be delivered from one location or a plurality of locations. In some embodiments, the computer program is delivered from a cloud computing service.

The computer program includes a web application written in one or more languages, such as, for example, Hypertext Markup Language (HTML), Extensible Hypertext Markup Language (XHTML), or eXtensible Markup Language (XML), Cascading Style Sheets (CSS), Asynchronous JavaScript, XML (AJAX), ActionScript, JavaScript, or Silverlight, Active Server Pages (ASP), ColdFusion®, Perl, Java™, Hypertext Preprocessor (PHP), Python™, and Ruby, Ruby on Rails (RoR), Structured Query Language (SQL), Microsoft®, SQL Server, mySQL™, and Oracle®.

The personal productivity and life enhancement tool is implemented as a web application, part of a web application, and the software modules are part of a web application.

The user interface is connected to a data storage device via the server. The data storage device can include memory in one or more physical apparatus used to store data or programs on a temporary or permanent basis. The data storage device is an electronic device that is configured to receive and aggregate the data from the user devices via the server. The data storage device may transmit the data to the server either directly or indirectly via a computing device (e.g., a mobile device or a personal computer) through a network, such as the Internet, using a portal, such as a web portal or a mobile portal, provided by the server. The data storage device allows the user to store and later retrieve any of the information that has been input to or generated by the modules and distribute it.

Data are also transmitted to the server. These types of data include user interactions between a user and the server containing the DIVAR modules. These user-interaction data may include questions and answers, social networking, games and other interactive interactions.

The following examples are provided to illustrate the invention.

The invention has been described in detail with particular reference to certain preferred embodiments thereof, but it will be understood that variations and modifications can be effected within the spirit and scope of the invention.

1. A cloud-based, personal productivity and life enhancement tool comprising a central server connected to the internet for containing personal productivity and life enhancement modules, wherein said personal productivity and life enhancement modules comprise a daily life log module, an illumination module, a vision module, an achievement module; and a revelation module, wherein the central server is connected to a searchable information database store for privately keeping user information generated from the personal productivity and life enhancement modules, and at least one user interface for accessing the personal productivity and life enhancement modules and searchable information database store.

2. The cloud-based, personal productivity and life enhancement tool of claim 1, wherein the daily life module comprises at least one of a daily log, time capsule, period log, mood inventory, coaching feature, to-do list, and revision feature.

3. The cloud-based, personal productivity and life enhancement tool of claim 2, wherein the daily life module comprises boards containing information from other modules.

4. The cloud-based, personal productivity and life enhancement tool of claim 1, wherein the illumination module comprises at least one of a dreams feature, a conversations feature, a meaning feature, and a history feature.

5. The cloud-based, personal productivity and life enhancement tool of claim 4, wherein the illumination module further comprises a twilight log for visually summarizing and analyzing dreams, conversations, meaning and history to illuminate patterns.

6. The cloud-based, personal productivity and life enhancement tool of claim 1, wherein the vision module comprises features for developing a personal vision statement, and goals.

7. The cloud-based, personal productivity and life enhancement tool of claim 1, wherein the features of the vision module are divided into eight categories of personal vision, personal care, relationships, family, spiritual growth, industry, contribution, and prosperity,

8. The cloud-based, personal productivity and life enhancement tool of claim 1, wherein the achievement module comprises a scorecard of goals.

9. The cloud-based, personal productivity and life enhancement tool of claim 1, wherein the achievement module calculates data from the vision module.

10. The cloud-based, personal productivity and life enhancement tool of claim 1, wherein the achievement module provides a life journey timeline.

11. The cloud-based, personal productivity and life enhancement tool of claim 1, wherein revelation module comprises a feature for writing stories.

12. The cloud-based, personal productivity and life enhancement tool of claim 1, wherein the revelation module comprises a feature for writing biographies and autobiographies.

13. The cloud-based, personal productivity and life enhancement tool of claim 1, wherein the revelation module contains features that are guided or unguided.

14. The cloud-based, personal productivity and life enhancement tool of claim 1, wherein the personal productivity and life enhancement modules further comprise web browser plug-ins, add-ins, add-ons, toolbars, or extensions.

15. The cloud-based, personal productivity and life enhancement tool of claim 1, wherein the central server connected to the internet is at least one of internet-based, world wide web-based or cloud computing-based.

16. A cloud-based, personal productivity and life enhancement tool comprising a central server connected to the internet and containing at least two personal productivity and life enhancement modules, wherein the central server is connected to a searchable information database store for privately keeping user information generated from the personal productivity and life enhancement modules, and at least one user interface for accessing the personal productivity and life enhancement modules and searchable information database store.

17. The cloud-based, personal productivity and life enhancement tool of claim 16, wherein the at least two cloud-based, personal productivity and life enhancement models are selected from a daily life log module, an illumination module, a vision module, an achievement module; and a revelation module.
